(19) United States
(12) Patent Application Publication
(10) Pub. No.: US 2026/0166718 A1
(43) Pub. Date: Jun. 18, 2026

(54) ROBOT AND METHOD FOR LUBRICATING ROBOT

(71) Applicant: KAWASAKI JUKOGYO KABUSHIKI KAISHA, Kobe-shi, Hyogo (JP)

(72) Inventors: Takeshi SHIBATA, Kobe-shi (JP); Ryota ONO, Kobe-shi (JP)

(73) Assignee: KAWASAKI JUKOGYO KABUSHIKI KAISHA, Kobe-shi, Hyogo (JP)

(21) Appl. No.: 18/724,359

(22) PCT Filed: Dec. 20, 2022
(86) PCT No.: PCT/JP2022/046871

§ 371 Date: Jun. 26, 2024

(30) Foreign Application Priority Data
Dec. 28, 2021 (JP) 2021-215292

(51) Int. Cl. B25J 9/10; B25J 17/00; B25J 19/00; F16H 57/04

(52) U.S. Cl. CPC B25J 9/102; B25J 17/00; B25J 19/0062; F16H 57/0464

(57) ABSTRACT

This robot is provided with a power transmission gear train for driving a joint. The robot is provided with a first gear, a second gear, and a lubrication gear. The second gear has a diameter larger than that of the first gear, and meshes with the first gear. The lubrication gear meshes with the first gear. The rotatable angle range of the joint is limited. The joint is caused to rotate within said rotatable angle range by rotary-driving the first gear in a state of being meshed with the second gear. The lubrication gear is formed of an oil-containing resin.

### TECHNICAL FIELD

The present disclosure relates to lubrication of a joint drive part of a robot.

### BACKGROUND ART

A configuration in which power of an electric motor is transmitted by a gear train to drive a joint of a robot has been conventionally known.

PTL 1 discloses a geared transmission having a configuration in which an input gear and an output gear are meshed. A diameter of the output gear is greater than that of the input gear. Two lubrication gears mesh with the output gear. Each of the lubrication gears is made of oil-containing resin. The two lubrication gears are arranged in pairs to sandwich a meshing part of the input gear and the output gear. However, PTL 1 does not disclose that such a gear system is applied to a robot.

### CITATION LIST

### Patent Literature

Patent Literature 1: Japanese Patent Application Laid-Open No. 2020-70855

### SUMMARY OF INVENTION

### Technical Problem

For example, in a robot conveying a workpiece, an angle range of a joint movement of the robot may be substantially restricted to a predetermined angle range, depending on a positional relationship between a source and destination of the workpiece. The angle range of the joint movement may be virtually restricted in order to avoid the robot from physically interfering with surrounding environment.

In such a configuration, only a part of an outer peripheral surface of a gear in a peripheral direction may mesh with a mating gear. In the configuration of PTL 1, the lubrication gears may lubricate unnecessary parts of the output gear, and therefore, a configuration that realizes efficient lubrication is desired.

The present invention has been made in view of the circumstances described above, its object is to realize efficient lubrication by a gear made of oil-containing resin.

### Solution to Problem

Problems to be solved by the present disclosure are as described above, and next, means for solving the problems and effects thereof will be described.

According to a first aspect of the present disclosure, a robot having the following configuration is provided. That is, the robot includes a power transmission gear train for driving a joint. The robot includes a first gear; a second gear, and a lubrication gear. The second gear has a larger diameter than a diameter of the first gear and meshes with the first gear. The lubrication gear meshes with the first gear. A rotation angle range of the joint is restricted. The first gear meshed with the second gear is rotationally driven to cause the joint to rotate within the rotation angle range. The lubrication gear is made of oil-containing resin.

According to a second aspect of the present disclosure, the following robot lubricating method is provided. That is, in the robot lubricating method, a first gear included in the robot is lubricated. A rotation angle range of a joint of the robot is restricted. The first gear meshes with a second gear having a larger diameter than a diameter of the first gear. The first gear meshed with the second gear is rotationally driven to cause the joint to rotate within the rotation angle range. A lubrication gear made of oil-containing resin meshes with the first gear. Lubrication is performed by a driven rotation of the lubrication gear in accordance with a rotation of the first gear.

Accordingly, lubricating oil contained in the lubrication gear can lubricate the first gear, and can indirectly lubricate a meshing part of the first gear and the second gear. Due to the meshing part of the first gear and the second gear, lubrication caused by the lubrication gear meshing with the first gear is less likely to be wasted. Therefore, efficient lubrication can be achieved.

### ADVANTAGEOUS EFFECTS OF INVENTION

According to the present disclosure, the gear made of oil-containing resin can realize efficient lubrication.

### BRIEF DESCRIPTION OF THE DRAWINGS

FIG. 1 is a cross-sectional plan view illustrating a part of semiconductor processing equipment to which a robot according to an embodiment of the present disclosure is applied.

FIG. 2 is a cross-sectional side view illustrating a part of the semiconductor processing equipment.

FIG. 3 is a perspective view illustrating a configuration of a robot system.

FIG. 4 is a perspective view illustrating a configuration of a first link of the robot.

### DESCRIPTION OF EMBODIMENTS

Next, an embodiment of the present disclosure will be described with reference to drawings.

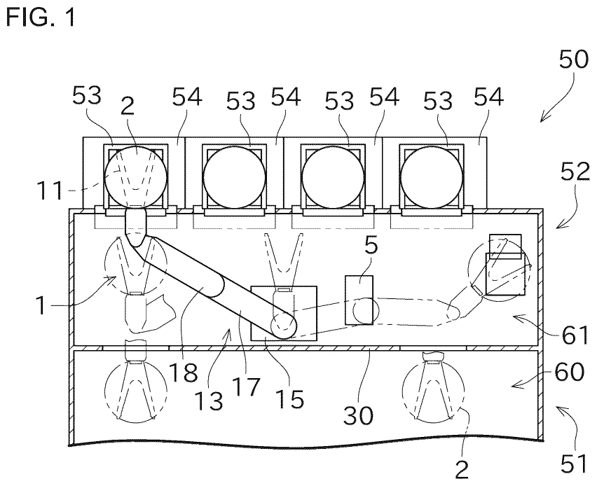

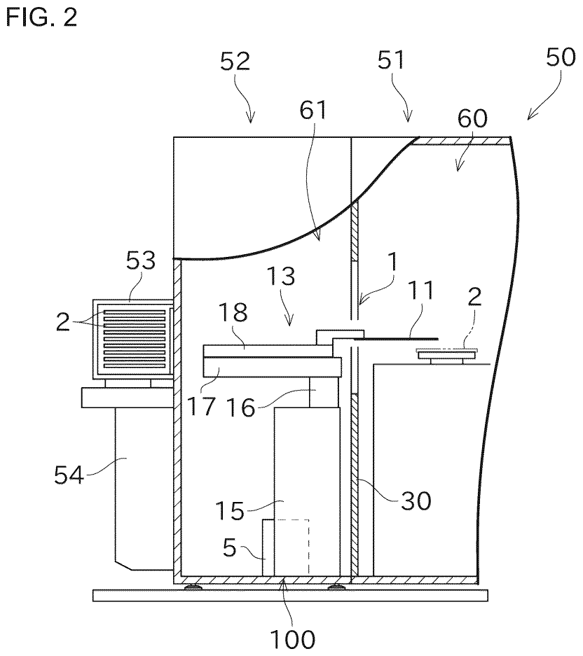

FIG. 1 is a cross-sectional plan view illustrating a part of semiconductor processing equipment 50 to which a robot 1 according to an embodiment of the present disclosure is applied. FIG. 2 is a cross-sectional side view in which a part of the semiconductor processing equipment 50 is cut. In FIG. 1 and FIG. 2, a state in which the robot 1 is moved in various ways is shown by two-dot chain lines.

The semiconductor processing equipment 50 performs predetermined processing on a wafer 2, which is a substrate to be processed. In the present embodiment, the wafer 2 is a semiconductor wafer. Examples of the processing performed on the wafer 2 include various treatments such as heat treatment, impurity introduction treatment, thin film formation treatment, lithography treatment, cleaning treatment, or planarization treatment. In the semiconductor processing equipment 50, any substrate treatment other than the above-mentioned substrate treatment may be performed.

The semiconductor processing equipment 50 includes a wafer processing device 51 and a wafer transfer device 52. The semiconductor processing equipment 50 is predefined, for example, by SEMI standards. SEMI is an abbreviation for Semiconductor Equipment and Materials International. In this case, a FOUP 53 and a FOUP opener 54 for opening and closing the FOUP 53 follow specifications of SEMI standards E47.1, E15.1, E57, E62, E63, E84, and the like. However, a configuration of the semiconductor processing equipment 50 may differ from the SEMI standards.

A processing space 60 is formed in the wafer processing device 51 and is filled with predetermined gas. In the processing space 60, the wafer processing device 51 performs the above-mentioned treatments on the wafer 2. The wafer processing device 51 includes a processing device main body that performs treatment on the wafer 2, a processing space forming part that forms the processing space 60, a conveying device that conveys the wafer 2 in the processing space 60, and an adjusting device that controls atmospheric gas that fills the processing space 60. The adjusting device is realized by a fan filter unit, and the like.

The wafer transfer device 52 takes out the wafer 2 before treatment from the FOUP 53, supplies the wafer 2 to the wafer processing device 51, also takes out the wafer 2 after treatment from the wafer processing device 51, and stores the wafer 2 again in the FOUP 53. The wafer transfer device 52 functions as front-end module equipment (Equipment Front End Module; EFEM). In the semiconductor processing equipment 50, the wafer transfer device 52 is an interface section that transfers the wafer 2 between the FOUP 53 and the wafer processing device 51. The wafer 2 passes through a preparation space 61 that is highly clean and filled with predetermined atmospheric gas while moving between a space within the FOUP 53 and the processing space 60 of the wafer processing device 51.

The preparation space 61 is a closed space where contamination control is performed. In the preparation space 61, suspended particulate matter in the air is controlled below a specified cleanliness level, and environmental conditions such as temperature, humidity, and pressure are also controlled as necessary. In the present embodiment, the processing space 60 and the preparation space 61 are kept at a predetermined cleanliness level so as not to adversely affect the treatment of the wafer 2. For example, CLASS1 as specified by ISO (International Organization for Standardization) is adopted as the cleanliness level.

The robot 1 functions as a wafer transfer robot. In the present embodiment, the robot 1 is realized by a SCARA-type horizontal articulated robot. SCARA is an abbreviation for Selective Compliance Assembly Robot Arm. The robot 1 is disposed in the preparation space 61.

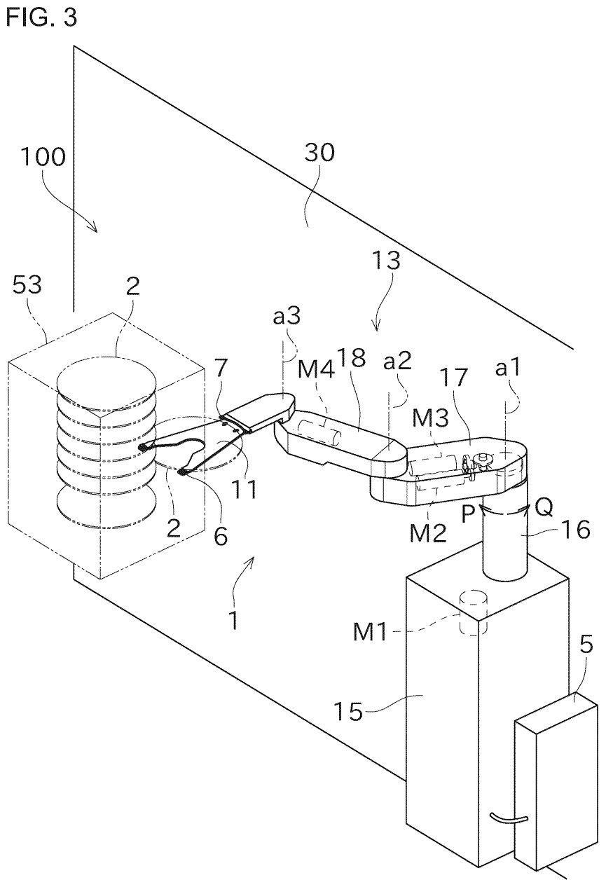

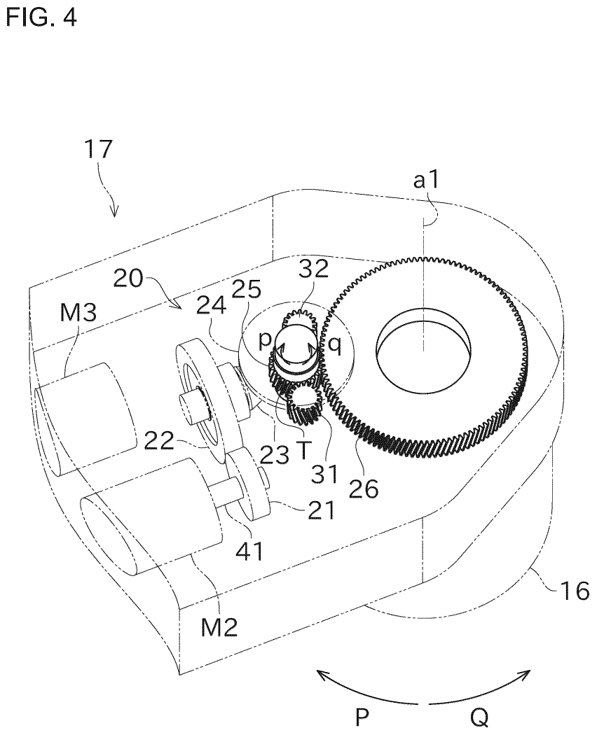

Next, details of a configuration of the robot 1 will be described. FIG. 3 is a perspective view illustrating a configuration of the robot 1. FIG. 4 is a perspective view illustrating a configuration of an inside of a first link 17 of the robot 1.

A robot system 100 includes the robot 1 and a controller 5.

The robot 1 includes a hand (holding part) 11 and a manipulator 13, as illustrated in FIG. 3.

The hand 11 is a type of end effector, and is generally formed in a V-shape or U-shape in a plan view. The hand 11 is supported at a distal end of the manipulator 13 (specifically, a second link 18, which will be described later). The hand 11 is rotatable about a third axis a3 that extends in a vertical direction relative to the second link 18.

The hand 11 is configured as an edge-grip type hand. An edge guide 6 is provided at each of distal ends branched in the hand 11. A pressing member 7 is provided near a wrist of the hand 11. The pressing member 7 moves toward the distal ends of the hand 11 by an unillustrated actuator (for example, a pneumatic cylinder) built into the wrist of the hand 11.

The pressing member 7 is displaced toward a side of the distal ends with the wafer 2 placed on a top side of the hand 11, so that the wafer 2 can be sandwiched and held between the edge guide 6 and the pressing member 7.

The manipulator 13 mainly includes a base 15, a lifting shaft 16, and a plurality of links (here, the first link 17 and the second link 18).

The base 15 is fixed onto a floor surface of the above-mentioned preparation space 61. The base 15 functions as a base member that supports lifting shaft 16.

The lifting shaft 16 is disposed so as to protrude upward from the base 15. The lifting shaft 16 moves in the vertical direction relative to the base 15. Such a movement in the vertical direction changes heights of the first link 17, the second link 18, and the hand 11.

The base 15 is equipped with a motor M1. The motor M1 drives the lifting shaft 16 through an unillustrated screw mechanism, for example.

The first link 17 is supported at an upper part of the lifting shaft 16. The first link 17 rotates around a first axis al that extends in the vertical direction relative to the lifting shaft 16. This allows an orientation of the first link 17 to be changed in a horizontal plane.

The first link 17 is equipped with a motor (electric motor) M2. The motor M2 drives the first link 17 so as to rotate relative to the lifting shaft 16.

The second link 18 is supported at a distal end of the first link 17. The second link 18 rotates around a second axis a2 that extends in the vertical direction relative to the first link 17. This allows an orientation of the second link 18 to be changed in a horizontal plane.

The first link 17 is equipped with a motor M3. The motor M3 drives the second link 18 so as to rotate relative to the first link 17.

The second link 18 is equipped with a motor M4. The motor M4 drives the hand 11 so as to rotate relative to the second link 18.

Each of the motors M1 to M4 is an actuator that moves each part of the robot 1. Each of the motors M1 to M4 is configured as a servo motor, a type of electric motor. Driving of the motors M1 to M4 can change positions and orientations of the hand 11 variously.

The motors M1 to M4 are electrically connected to the controller 5 via an unillustrated cable. The controller 5 is a device that gives various commands to the robot 1 to operate the robot 1, and is formed by a known computer. Each of the motors M1 to M4 is driven to reflect a command value input from the controller 5.

Next, a configuration for causing the first link 17 to rotate around the first axis al will be described with reference to FIG. 4.

A power transmission gear train 20 for transmitting a rotation of an output shaft 41 of the motor M2 is disposed inside the first link 17. As illustrated in FIG. 4, the power transmission gear train 20 includes a first transmission gear 21, a second transmission gear 22, an input bevel gear 23, an output bevel gear 24, and an output gear (first gear) 25. The output gear 25 meshes with a fixed gear (second gear) 26. In FIG. 4, in order to clearly show a configuration of surroundings of the output gear 25 and the fixed gear 26, a configuration on a drive train upstream-side relative to the output bevel gear 24 is illustrated transparently with chain lines.

The first transmission gear 21, the second transmission gear 22, the input bevel gear 23, the output bevel gear 24, the output gear 25, and the fixed gear 26 are all made of metal. However, these gears may be made of a material other than metal, such as synthetic resin.

The first transmission gear 21 is fixed to a distal end of the output shaft 41 of the motor M2. A housing of the motor M2 is fixed at a position near a center in a longitudinal direction of the first link 17. The output shaft 41 of the motor M2 protrudes in a direction approaching the first axis al along the longitudinal direction of the first link 17.

The second transmission gear 22 is rotatably supported in the first link 17. A rotational axis of the second transmission gear 22 is parallel to a rotational axis of the first transmission gear 21. The second transmission gear 22 meshes with the first transmission gear 21. A diameter of the second transmission gear 22 is greater than that of the first transmission gear 21.

The input bevel gear 23 is rotatably supported in the first link 17. A rotational axis of the input bevel gear 23 is the same as the rotational axis of the second transmission gear 22. The input bevel gear 23 is oriented such that a diameter thereof on a side close to the first axis al is small. The input bevel gear 23 is fixed to the second transmission gear 22. Thus, the second transmission gear 22 and the input bevel gear 23 rotate integrally.

The output bevel gear 24 is rotatably supported in the first link 17. A rotational axis of the output bevel gear 24 is oriented in the vertical direction. A rotational axis of the output bevel gear 24 is located closer to the first axis al relative to a distal end of the input bevel gear 23. The output bevel gear 24 meshes with the input bevel gear 23. A diameter of the output bevel gear 24 is greater than that of the input bevel gear 23.

The output gear 25 is rotatably supported in the first link 17. A rotational axis of the output gear 25 is the same as a rotational axis of the output bevel gear 24. The output gear 25 is formed as a helical gear.

The fixed gear 26 is fixed at an upper end of the lifting shaft 16. A central axis of the fixed gear 26 coincides with the first axis al. As with the output gear 25, the fixed gear 26 is also formed as a helical gear. The fixed gear 26 meshes with the output gear 25. A diameter of the fixed gear 26 is greater than that of the output gear 25.

In the above-mentioned configuration, when the motor M2 rotates, rotation of the output shaft 41 is transmitted to the first transmission gear 21, the second transmission gear 22, the input bevel gear 23, the output bevel gear 24, and the output gear 25 in this order, so that the output gear 25 is driven. The output gear 25 related to the fixed gear 26 functions as a planetary gear in relation to the fixed gear 26, and the first link 17 corresponds to a planetary carrier. The output gear 25 meshing with the fixed gear 26 rotates, so that the first link 17 can rotate appropriately relative to the lifting shaft 16.

As described above, the power transmission gear train 20 transmits power of the motor M2 to allow the first link 17 to rotate.

The first transmission gear 21, the second transmission gear 22, the input bevel gear 23, and the output bevel gear 24 form a reduction gear train. Thus, as compared with the rotation of the output shaft 41 of the motor M2, the rotation of the output gear 25 is decelerated and a rotational torque is increased.

The robot 1 of the present embodiment is disposed in the narrow preparation space 61, and located close to a wall 30 of the preparation space 61, as illustrated in FIG. 3, for example. Thus, an angle at which the first link 17 rotates relative to the lifting shaft 16 is essentially restricted to a range of 180 degrees or less in order to avoid interference with surroundings. When the robot 1 conveys a plurality of wafers 2, the first link 17 repeats a reciprocating drive in a P direction and a Q direction within the above-described rotation angle range.

Next, lubrication gears 31, 32 will be described.

The two lubrication gears 31, 32 are arranged in pairs to sandwich the output gear 25. The two lubrication gears 31, 32 are substantially symmetrical to each other with respect to a meshing part of the output gear 25 and the fixed gear 26.

As with the output gear 25, each of the lubrication gears 31, 32 is formed as a helical gear. The lubrication gears 31,32 are formed of synthetic resin impregnated with lubricating oil. The lubrication gears 31, 32 can be obtained by molding resin containing grease into a shape of a gear, for example.

The lubricating oil oozing out from surfaces of the lubrication gears 31, 32 can lubricate surfaces of teeth of the output gear 25. Thus, the meshing part of the output gear 25 and the fixed gear 26 is appropriately lubricated, which effectively reduces wear of teeth of the fixed gear 26. As a result, hysteresis related to rotational movement of the first link 17 can be reduced and positional accuracy of the robot 1 can be improved.

Each of the lubrication gears 31, 32 is rotatably supported relative to the first link 17. In order to accommodate the output gear 25, an unillustrated housing is provided inside the first link 17. Grease, which will be described later, can be held inside the housing. Inside the housing, two substantially cylindrical spaces are formed adjacent to an accommodation space for the output gear 25. The lubrication gears 31, 32 are arranged in two spaces, respectively, which rotatably supports the lubrication gears 31, 32.

Each of rotation axes of the lubrication gears 31, 32 is parallel to the rotational axis of the output gear 25. The two lubrication gears 31, 32 mesh with the output gear 25. The two lubrication gears 31, 32 are arranged close to the fixed gear 26, but do not mesh with the fixed gear 26.

Along with a drive of the output gear 25, the output gear 25 moves on an outer peripheral surface of the fixed gear 26 in a rolling manner. The teeth of the output gear 25 mesh with either of the two lubrication gears 31, 32 when the output gear 25 rotates approximately 90 degrees in any direction from a phase in which the teeth of the output gear 25 mesh with the fixed gear 26.

As described above, the lubrication gears 31, 32 are impregnated with the lubricating oil. Thus, each time the output gear 25 meshes with the lubrication gears 31, 32, the teeth of the output gear 25 are lubricated. The grease is applied to the surfaces of the teeth of the output gear 25 when the robot 1 is shipped from a factory or during maintenance work of the robot 1. The output gear 25 meshes with the lubrication gears 31, 32 and rotates, so that the grease is distributed to the surfaces of the teeth of the output gear 25 via surfaces of teeth of the lubrication gears 31, 32. As such, in the sense of supplying the grease, the teeth of the output gear 25 are lubricated by meshing with the lubrication gears 31, 32.

As described above, the angle range in which the first link 17 rotates relative to the lifting shaft 16 is restricted to angles less than 360 degrees. This means that, when focusing on one tooth of the fixed gear 26, a mating tooth meshing with such one tooth of the fixed gear 26 is always specified to be only one tooth of the output gear 25.

Since the output gear 25 meshes with the fixed gear 26, the output gear 25 rotates and revolves relative to the fixed gear 26 at the same time. Such revolution of the output gear 25 corresponds to the rotation of the first link 17 relative to the lifting shaft 16. The rotation of the output gear 25 in a p direction allows the first link 17 to rotate in a P direction. The rotation of the output gear 25 in a q direction allows the first link rotates in a Q direction. As described above, the angle range at which the first link 17 rotates is restricted. However, the angle range is greater than a revolution angle range of the output gear 25 corresponding to 360 degrees rotation of the output gear 25.

A tooth T, one of a plurality of teeth of the output gear 25 will be focused, When the output gear 25 rotates in the q direction, the tooth T comes into contact with the lubrication gear 31 and is lubricated once every rotation of the output gear 25. The output gear 25 further rotates by a predetermined angle in the q direction, so that the tooth T lubricated by the lubrication gear 31 meshes with a tooth of the fixed gear 26. As a result, the tooth of the fixed gear 26 is indirectly lubricated.

The following case will be considered; a rotation direction of the first link 17 is switched to the P direction before the tooth T of the output gear 25 meshed with the lubrication gear 31, in the process of the rotation of the output gear 25 in the q direction to cause the first link 17 to rotate in the Q direction, reaches the meshing part with the fixed gear 26. Even in this case, the tooth T is to mesh with the fixed gear 26 when the output gear 25 rotates by a predetermined angle smaller than 360 degrees in the p direction. As such, an opportunity in which the lubrication gear 31 indirectly lubricates the meshing part of the output gear 25 and the fixed gear 26 is less likely to be lost by switching of the rotation direction of the first link 17, according to a configuration of the present embodiment. In other words, a part of the fixed gear 26 without meshing with the output gear 25 is not indirectly lubricated. Therefore, lubrication by the lubrication gear 31 can be performed efficiently.

The lubrication gear 32 is disposed at a position symmetrical to the lubrication gear 31 with respect to the meshing part of the output gear 25 and the fixed gear 26. Therefore, the same applies to the lubrication gear 32, as with the above-described lubrication gear 31. That is, an opportunity in which the lubrication gear 32 indirectly lubricates the meshing part of the output gear 25 and the fixed gear 26 is less likely to be lost by switching of the rotation direction of the first link 17.

The output gear 25 meshes with both the lubrication gear 31 and the fixed gear 26. Therefore, in the output gear 25, an angle between the meshing part of the output gear 25 and the lubrication gear 31 and the meshing part of the output gear 25 and the fixed gear 26 is, of course, smaller than 360 degrees. In the present embodiment, the two lubrication gears 31, 32 are provided symmetrical to each other, and each of the lubrication gears 31, 32 is disposed close to the meshing part of the output gear 25 and the fixed gear 26. Thus, the angle between the meshing part of the output gear 25 and the lubrication gear 31 and the meshing part of the output gear 25 and the fixed gear 26 is smaller than 180 degrees and slightly smaller than 90 degrees.

In the present embodiment, the output gear 25 is sandwiched between the input bevel gear 23 and the fixed gear 26. Thus, in order to avoid physical interference, it is unavoidable that the lubrication gear 31 is disposed at a position biased to a side relative to an imaginary line connecting a center of the output gear 25 and a center of the fixed gear 26. A rotational distance from when the tooth T of the output gear 25 meshes with the lubrication gear 31 to when the tooth T meshes with the fixed gear 26 varies depending on whether the output gear 25 rotates in the p direction or the q direction. Therefore, regarding the teeth of the fixed gear 26, lubrication unevenness may occur locally in a peripheral direction of the fixed gear 26.

In this regard, in the present embodiment, the lubrication gear 32 is disposed on an opposite side of the above-mentioned imaginary line relative to the lubrication gear 31. Therefore, an opportunity to indirectly lubricate the meshing part of the output gear 25 and the fixed gear 26 can be simply doubled, and at the same time, a configuration in which lubrication unevenness depending on the rotation direction is less likely to be caused.

The oil-containing resin that is a material of each of the lubrication gears 31, 32 is softer than metal, and the like. In this regard, in the present embodiment, the grease is applied to the surfaces of the teeth of the output gear 25 in advance. This effectively reduces wear of the lubrication gears 31, 32 and increases durability.

The robot 1 of the present embodiment operates in a clean environment, and human intervention for maintenance is not preferred for the clean environment. The robot 1 is generally placed in a closed space such as a clean room and a vacuum container, and therefore, the maintenance is difficult. In this respect, according to a configuration of the present embodiment, a required maintenance frequency is reduced, so that downtime is reduced to increase production amount. In addition, since the robot 1 operates in a well-lubricated state, a quality of a substrate can also be improved.

As described above, the robot 1 of the present embodiment includes the power transmission gear train 20 for driving a joint relating to the first axis al. The robot 1 includes the output gear 25, the fixed gear 26, and the lubrication gears 31, 32. The fixed gear 26 has a greater diameter than that of the output gear 25, and meshes with the output gear 25. The lubrication gears 31, 32 mesh with the output gear 25. A rotation angle range of the joint relating to the first axis al is restricted. The output gear 25 meshed with the fixed gear 26 is rotationally driven, which causes the first link 17 to rotate within the rotation angle range regarding the joint. The lubrication gears 31, 32 are made of oil-containing resin.

Accordingly, lubricating oil contained in the lubrication gears 31, 32 lubricates the output gear 25, also indirectly lubricates the meshing part of the output gear 25 and the fixed gear 26. Although the first link 17 performs a rotational reciprocating movement at an angle smaller than 360 degrees, the lubrication gears 31, 32 directly lubricate the output gear 25 rather than the fixed gear 26. Thus, even when a rotational direction of the first link 17 is reversed before a part of the output gear 25 in which the lubrication gears 31, 32 mesh with and lubricate the output gear 25 meshes with the fixed gear 26, such a part is to eventually mesh with the fixed gear 26 due to a reverse rotation of the output gear 25. As such, due to the meshing part of the output gear 25 and the fixed gear 26, lubrication caused by the lubrication gears 31, 32 meshing with the output gear 25 is less likely to be wasted. This can achieve efficient lubrication.

In the robot 1 of the present embodiment, a plurality of lubrication gears 31 are provided.

Accordingly, an opportunity of lubrication in the process of rotation of the output gear 25 increases. Therefore, an opportunity in which the meshing part of the output gear 25 and the fixed gear 26 is indirectly lubricated increases.

In the robot 1 of the present embodiment, two lubrication gears 31 are arranged on opposite sides of the meshing part of the output gear 25 and the fixed gear 26.

Accordingly, when the first link 17 rotates in the P direction, the rotation angle of the output gear 25 from when one of the teeth of the output gear 25 meshes with the lubrication gear 32 to when the one of the teeth of the output gear 25 meshes with the fixed gear 26 is to be less than 180 degrees. When the first link 17 rotates in the Q direction, the rotation angle of the output gear 25 from when one of the teeth of the output gear 25 meshes with the lubrication gear 31 to when the one of the teeth of the output gear 25 meshes with the fixed gear 26 is to be less than 180 degrees. This can prevent lubrication unevenness of the fixed gear 26.

In the robot 1 of the present embodiment, grease is applied to an outer periphery of the lubrication gear 31 where the teeth are arranged.

As a result, a lubrication effect of the output gear 25 can be increased.

In the robot 1 of the present embodiment, the power transmission gear train 20 includes a reduction gear mechanism that reduces a rotation of the motor M2. The output gear 25 is an output gear that is a final reduction stage of the reduction gear mechanism.

In the present embodiment, the lubrication gear 31 is configured to mesh with the output gear 25 that rotates at the slowest speed in the power transmission gear train 20. Thus, lubricating oil is less likely to be lost due to a centrifugal force, and the like that acts on outer peripheral surfaces of the lubrication gears 31, 32. As a result, the lubrication effect can be further increased.

Although a preferred embodiment of the present disclosure has been described as above, the above-described embodiment may be modified as follows, for example. The embodiment may be modified independently, or modifications may be combined arbitrarily.

The number of the lubrication gears 31, 32 is not limited to two, and may be changed to one or three or more.

A plurality of lubrication gears 31, 32 may be provided on the same side relative to an imaginary line connecting a center of the output gear 25 and a center of the fixed gear 26.

Grease may be applied to surfaces of teeth of the lubrication gears 31, 32, in addition to or instead of the surfaces of the teeth of the output gear 25. On the other hand, grease application to the surfaces of the teeth of the output gear 25 may be omitted.

The lubrication gears 31, 32 may be configured to mesh with a gear on a drive train upstream-side relative to the output gear 25 (for example, the first transmission gear 21, the input bevel gear 23, and the like), instead of the output gear 25. The lubrication gears 31, 32 may be formed as bevel gears.

The output gear 25, the fixed gear 26, and the lubrication gears 31, 32 may be changed from spur gears to helical gears.

In the above-mentioned embodiment, restriction on the rotation angle range of the first link 17 is practically achieved by a control by the controller 5 (without instructing rotation toward a position outside the above-mentioned rotation angle range). However, the restriction on the rotation angle range can also be achieved with a stop member, for example.

The fixed gear 26 may be formed as a sector gear in which teeth are formed only in an area corresponding to the first link 17.

The robot 1 can be used in both clean and non-clean environments. The robot 1 can also be used in a situation where there is no restriction on the rotation angle of the first link 17.

A configuration of lubrication by the lubrication gears 31, 32 of the present embodiment may be applied to a joint of the robot 1 that is different from the first axis al.

A configuration of lubrication by the lubrication gears 31, 32 of the present embodiment may be applied to a robot that conveys a workpiece having a shape that is different from a plate-like shape.

According to the above-mentioned disclosure, at least the following technical ideas can be obtained.

(Item 1) A robot equipped with a power transmission gear train for driving a joint comprising:
a first gear;
a a second gear that has a larger diameter than a diameter of the first gear and meshes with the first gear; and
a a lubrication gear that meshes with the first gear, wherein
a a rotation angle range of the joint is restricted,
a the first gear meshed with the second gear is rotationally driven to cause the joint to rotate within the rotation angle range, and
a the lubrication gear is made of oil-containing resin.

(Item 2) The robot according to Item 1, wherein
a the robot comprises a plurality of the lubrication gears.

(Item 3) The robot according to Item 2, wherein
a the robot comprises two of the lubrication gears arranged to sandwich a meshing part of the first gear and the second gear.

(Item 4) The robot according to any one of Items 1 to 3, wherein
a grease is applied to a surface of a tooth of at least one of the first gear and the lubrication gear.

(Item 5) The robot according to any one of Items 1 to 4, wherein
a the power transmission gear train includes a reduction gear mechanism configured to reduce a rotation of an electric motor, and
a the first gear is an output gear that is a final reduction stage of the reduction gear mechanism.

(Item 6) The robot according to any one of Items 1 to 5, wherein
a the robot is configured to convey a substrate as a workpiece.

(Item 7) A robot lubricating method of lubricating a first gear included in the robot, wherein
a a rotation angle range of a joint of the robot is restricted,
a a first gear meshes with a second gear having a larger diameter than a diameter of the first gear,
a the first gear meshed with the second gear is rotationally driven to cause the joint to rotate within the rotation angle range,
a a lubrication gear made of oil-containing resin meshes with the first gear, and
a lubrication is performed by a driven rotation of the lubrication gear in accordance with a rotation of the first gear.

1. A robot equipped with a power transmission gear train for driving a joint comprising:
a first gear;
a second gear that has a larger diameter than a diameter of the first gear and meshes with the first gear; and
a lubrication gear that meshes with the first gear, wherein
a a rotation angle range of the joint is restricted,
a the first gear meshed with the second gear is rotationally driven to cause the joint to rotate within the rotation angle range, and
a the lubrication gear is made of oil-containing resin.

2. The robot according to claim 1, wherein
a the robot comprises a plurality of the lubrication gears.

3. The robot according to claim 2, wherein
a the robot comprises two of the lubrication gears arranged to sandwich a
a meshing part of the first gear and the second gear.

4. The robot according to claim 1, wherein
a grease is applied to a surface of a tooth of at least one of the first gear and the lubrication gear.

5. The robot according to claim 1, wherein
a the power transmission gear train includes a reduction gear mechanism configured to reduce a rotation of an electric motor, and
a the first gear is an output gear that is a final reduction stage of the reduction gear mechanism.

6. The robot according to claim 1, wherein
a the robot is configured to convey a substrate as a workpiece.

7. A robot lubricating method of lubricating a first gear included in the robot, wherein
a a rotation angle range of a joint of the robot is restricted,
a the first gear meshes with a second gear having a larger diameter than a diameter of the first gear,
a the first gear meshed with the second gear is rotationally driven to cause the joint to rotate within the rotation angle range,
a a lubrication gear made of oil-containing resin meshes with the first gear, and
a lubrication is performed by a driven rotation of the lubrication gear in accordance with a rotation of the first gear.
